(19) United States
(12) Patent Application Publication
(10) Pub. No.: US 2011/0225050 A1
(43) Pub. Date: Sep. 15, 2011

(54) Intelligent Selection Based on Customized Palate Preferences

(76) Inventor: Thomas Varghese, San Mateo, CA (US)

(21) Appl. No.: 13/046,482

(22) Filed: Mar. 11, 2011

Related U.S. Application Data
(60) Provisional application No. 61/312,831, filed on Mar. 11, 2010.

(51) Int. Cl. G06Q 30/00; G06N 5/02

(52) U.S. Cl. 705/14.66; 706/54

(57) ABSTRACT

A system and process for intelligently selecting consumable goods, comprising a consumer palate preference device capable of indicating a consumer's palate preferences, a consumable good having attributes, whereby the consumer's palate preferences are compared against the attributes of the consumable good to determine selection. Another aspect of the present invention includes a method of intelligently selecting a consumable good, comprising the steps of using a consumer palate preference device having consumer's palate preferences, comparing the consumer's palate preferences to a consumable good having attributes, and selecting the consumable good based on the consumer's palate preferences. Another aspect of the present invention includes a method of labeling consumable goods, comprising the steps of creating attributes for the consumable goods, scoring the attributes for the consumable goods, and associating the scores of the attributes with the consumable goods. Another aspect of the present invention includes a method of intelligently pairing consumable goods, comprising the steps of creating attributes for at least two separate consumable goods, scoring the attributes for the separate consumable goods, obtaining a consumer's palate preferences, and pairing the separate consumable goods based on the consumer's palate preferences. Another aspect of the present invention includes a method of promoting consumable goods, comprising the steps of obtaining a consumer's palate preferences, scoring the consumer's palate preferences, creating attributes for a consumable good, scoring the attributes of the consumable good, and using the consumer's palate preferences to promote consumable goods suited to the consumer's palate preferences.

### RELATED APPLICATION

This application claims priority to and the benefit of pending U.S. Provisional Patent Application Ser. No. 61/312,831, filed on Mar. 11, 2010, titled “Intelligent Selection Based on Customized Palate Preferences,” under 35 U.S.C. §119(e)(1), which is hereby incorporated by reference in its entirety for all purposes.

### FIELD OF THE INVENTION

The present invention relates generally to the field of intelligent selection of certain consumable goods based on customized palate preferences. The present invention can be applied to any industry in which consumable goods have identifiable characteristics and classifications.

### BACKGROUND OF THE INVENTION

Human beings make selections of consumable goods such as, for example, alcoholic beverages, sauces, jams, cheeses, breads, pastas, rice, tea, cigars, cigarettes, tobacco, or any other consumable good, on a daily basis. Questions such as, for example, “what shall we eat for lunch” or “what wine shall we pair with dinner” are asked millions of times by millions of people throughout the world. At home, in their surroundings, individuals typically surround themselves with consumable goods that they are familiar with and that they have tried. For example, a certain brand of coffee and cheeses are kept in the cupboard and refrigerator, perhaps because the consumer has tried that brand in the past and prefers it to other brands. Consumers will rarely deviate from the tried-and-tested brand because they may not be inclined to take a risk and waste their money on consumable products they may not like. Similarly, for example, when shopping for consumable goods, for example at a grocery store, the consumer will only purchase those consumable products which have been tried-and-tested by the consumer. How many times have consumers purchased new consumable products, took for example, one teaspoon of it, and ended up throwing it away?

Outside the comfort of home, consumers are typically even more at a loss. For example, if a consumer is at a restaurant that offers, for example, wine that the consumer is not familiar with, the consumer either does not order any wine or may blindly choose a wine that the consumer has no idea whether he or she will enjoy it. If the consumer ends up not liking the wine, the consumer will invariably have a bad experience at the restaurant.

The present invention relates to a system, method and apparatus to enable consumers to make intelligent selections of consumable goods, such as, for example, alcoholic beverages, sauces, jams, cheeses, breads, pastas, rice, tea, cigars, cigarettes, tobacco, or any other consumable good, based on customized palate preferences. Aspects of the present invention create a powerful tool for advertisers, marketers, and retailers. Consumable goods can be marketed to consumers with higher degree of success and can create a greater opportunity to upsell consumable goods the consumer might not otherwise have considered.

### SUMMARY OF THE INVENTION

An aspect of the present invention includes a system for intelligently selecting consumable goods, comprising a consumer palate preference device capable of indicating a consumer's palate preferences, a consumable good having attributes, whereby the consumer's palate preferences are compared against the attributes of the consumable good to determine selection.

Another aspect of the present invention includes a method of intelligently selecting a consumable good, comprising the steps of using a consumer palate preference device having consumer's palate preferences, comparing the consumer's palate preferences to a consumable good having attributes, and selecting the consumable good based on the consumer's palate preferences.

Another aspect of the present invention includes a method of labeling consumable goods, comprising the steps of creating attributes for the consumable goods, scoring the attributes for the consumable goods, and associating the scores of the attributes with the consumable goods. Another aspect of the present invention includes a method of intelligently pairing consumable goods, comprising the steps of creating attributes for at least two separate consumable goods, scoring the attributes for the separate consumable goods, obtaining a consumer's palate preferences, and pairing the separate consumable goods based on the consumer's palate preferences.

Another aspect of the present invention includes a method of promoting consumable goods, comprising the steps of obtaining a consumer's palate preferences, scoring the consumer's palate preferences, creating attributes for a consumable good, scoring the attributes of the consumable good, and using the consumer's palate preferences to promote consumable goods suited to the consumer's palate preferences.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1 illustrates a diagram of an exemplary embodiment of the present invention depicting an exemplary list of attributes.

FIG. 2 illustrates a diagram of an exemplary embodiment of the present invention depicting an exemplary list of sub-attributes.

FIG. 3 illustrates a diagram of an exemplary embodiment of the present invention depicting an exemplary results based on preferences.

FIG. 4 illustrates a diagram of an exemplary embodiment of the present invention depicting an exemplary consumable good, a bottle of wine.

FIG. 5 illustrates a diagram of an exemplary embodiment of the present invention depicting an exemplary attribute marker for an exemplary consumable good, here a bottle of wine.

FIG. 6 illustrates a diagram of an exemplary embodiment of the present invention depicting the intelligent selection system.

FIG. 7 illustrates a flowchart of an exemplary embodiment of the present invention depicting the major steps of the processing method.

FIG. 8 illustrates a flowchart of an exemplary embodiment of the present invention depicting the major steps of the processing method.

FIG. 9 illustrates a flowchart of an exemplary embodiment of the present invention depicting the major steps of the processing method.

### DETAILED DESCRIPTION OF THE INVENTION

The following is a detailed description of the exemplary embodiments of the present system, method, and apparatus to enable consumers to make intelligent selections of consumable goods. However, the present invention is in no way intended to be limited to the embodiments discussed below or shown in the drawings. Rather, the description and drawings are merely illustrative of the exemplary and presently preferred embodiments of the invention.

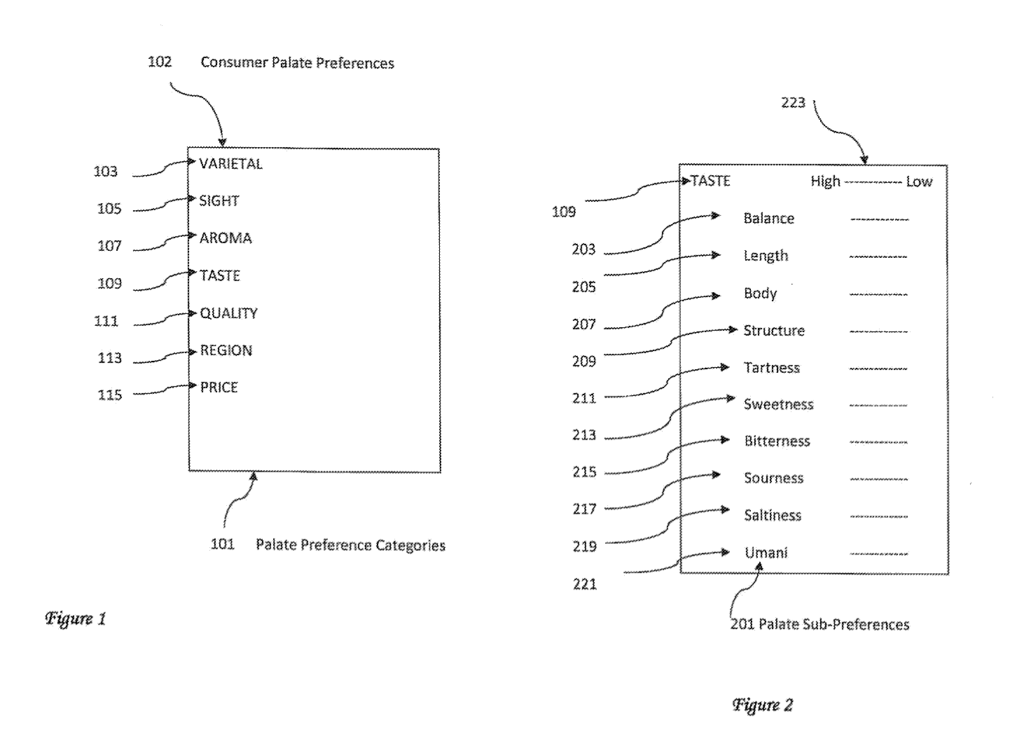

FIG. 1 illustrates an embodiment of the present invention, where there is shown, for example, an exemplary list of consumer palate preference categories 101, with an exemplary list of palate preferences 102, such as varietal 103, sight 105, aroma 107, taste 109, quality 111, region 113, price range 115 obtained from a consumer for a specific consumable good, such as, for example, wine. The above listed palate preference categories 101 are for exemplary purposes only and any number of attributes can be included for a specific consumable good.

FIG. 2 illustrates an embodiment of the present invention, where there is shown, for example, an exemplary palate preference 102, such as taste 109, where for example, a further list of exemplary palate sub-preferences 201 are obtained from the consumer and are associated with the attribute preference 109. As an example, palate sub-preferences 201 obtained from a consumer are associated with taste preference 109, include, for example balance 203, length 205, body 207, structure 209, tartness 211, sweetness 213, bitterness 215, sourness 217, and saltiness 219, umami 221. The above listed palate sub-preference categories 201 are for exemplary purposes only and any number of sub-preferences can be included for a specific palate preference category 101. For each sub-preference, the consumer identifies its preferences based on a scale 223 which can be from “High to Low” or numbering system, 1, 2, 3, 4, 5, etc., color-coding (dark color to light color) or any other similar range, measurement, identification or alphanumeric system in which the consumer provides his/her feedback on his/her preferences.

In an embodiment a customized set of palate preferences can be obtained from a consumer once he/she provides personal information about his/her palate based on the attributes of the consumable good. For example, if the consumable good is wine, the consumer will quantify his taste/palate as to the different characteristics and classifications of the wine. The consumer will rate or assign a factor to the price point, sight (clarity, depth, color, viscosity), aroma, taste (sweetness, tannin content, acidity, body, length, balance), quality identifier (coarse, poor, fine, excellent), region, types of grapes used, or any other similar characteristic based on his/her preferences. The consumer's preferences can be assigned or scored, for example, an alphanumeric value, however any other assignable system can be used, such as, for example, color codes, symbols, shapes, etc., that corresponds to the consumer's preferred consumable good. In an embodiment, the consumer's customized palate preferences can be saved in a database. In another embodiment, the consumer's palate preference can be stored on the consumer palate preference device, such as a smart card or a hand held electronic device, such as a Smartphone, PDA, or for example, in the form of a software application stored on an electronic device, in a manner well known to those skilled in the art.

Other factors, such as, age may also be used to contribute to consumable goods preferences. As a person ages, consumable goods preferences may change due to a possible diminished perception of taste/palate. An altered perception of taste/palate may also account for why a child who dislikes a particular food often develops a preference for it later in life. For example, a fetus may be introduced to elements in the mother's diet, as flavors are passed into the amniotic fluid, as shown by research conducted by the Monell Center. According to researchers at the Center, a late-term fetus has functional chemosensory systems that can detect taste and odors.

According to The European Nutrigenomics Organisation, humans can recognize approximately 10,000 odors. Because olfactory senses are linked to flavor perception, odor may play a role in food preference and consequently health status. Simply put, children like food that tastes good to them. Adults also prefer food that appeals to both their sense of taste and smell. But the genetic influences that affect those senses are not quite so simple. As researchers learn more about the sense of taste they also learn how genes influence dietary choices and the subsequent health conditions that often stem from or are affected by the foods we eat.

In another embodiment, a consumer's taste/palate preferences can be matched to genetic markers that can provide guidance in creating recommendations, suggestions for consumable goods and more precisely estimate or identify decisions that the consumer will make—without the need for medical diagnosis. For example, there are a number of factors that underline the genetic basis of taste. This can be revealed by using the bitter taste test PTC (phenylthiocarbamide). The exact biological functions of taste buds are still being studied, such as, for example, the reasons why some people are considered to be supertasters.

Since the early 20th century, it has been determined that some aspects of the sensation of taste are related to genetics. Recent studies have identified the existence of different proteins as being fully responsible for taste. These proteins come in the form of receptors that are found on taste buds—the small structures that exist on the upper surface of the tongue and are integral for the sensation of taste. As saliva begins to break down food, it comes in contact with the taste buds which house taste receptors. The 10,000 taste buds on an average human tongue then send information gathered in these receptors to the brain via cranial nerves.

Each taste experience is caused by a specific type of receptor on the taste bud. For example, bitterness has been shown to be caused by the receptors TAS2R38 and gustducin, a G protein. Sodium ions are specifically responsible for saltiness. Acidity is detected by hydronium ions creating the sensation of sourness. Sweetness is felt by the presence of sugars, aldehydes and ketones found on the taste buds. Still being fully understood, fermented and aged foods produce the taste sensation known as umami. The umami taste is due to the detection of the carboxylate anion of glutamic acid, a naturally occurring amino acid common in meat, cheese, broth, stock, and other protein-heavy foods. Salts of glutamic acid, known as glutamates, easily ionize to give the same carboxylate form and therefore the same taste. For this reason, they are used as flavor enhancers. The most commonly used of these is monosodium glutamate (MSG). While the umami taste is due to glutamates, 5′-ribonucleotides, such as, guanosine monophosphate (GMP) and inosine monophosphate (IMP) greatly enhance its perceived intensity. Since these ribonucleotides are also acids, their salts are sometimes added together with glutamates to obtain a synergistic flavor enhancement effect. It is believed that the receptor CD36 is responsible for identifying fatty acids, although research is still being conducted. CaSR was discovered on the tongues of mice in 2008. This is believed to be responsible for identifying calcium.

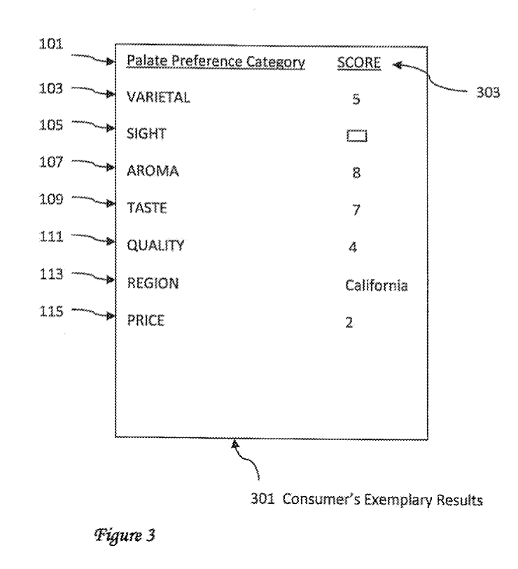

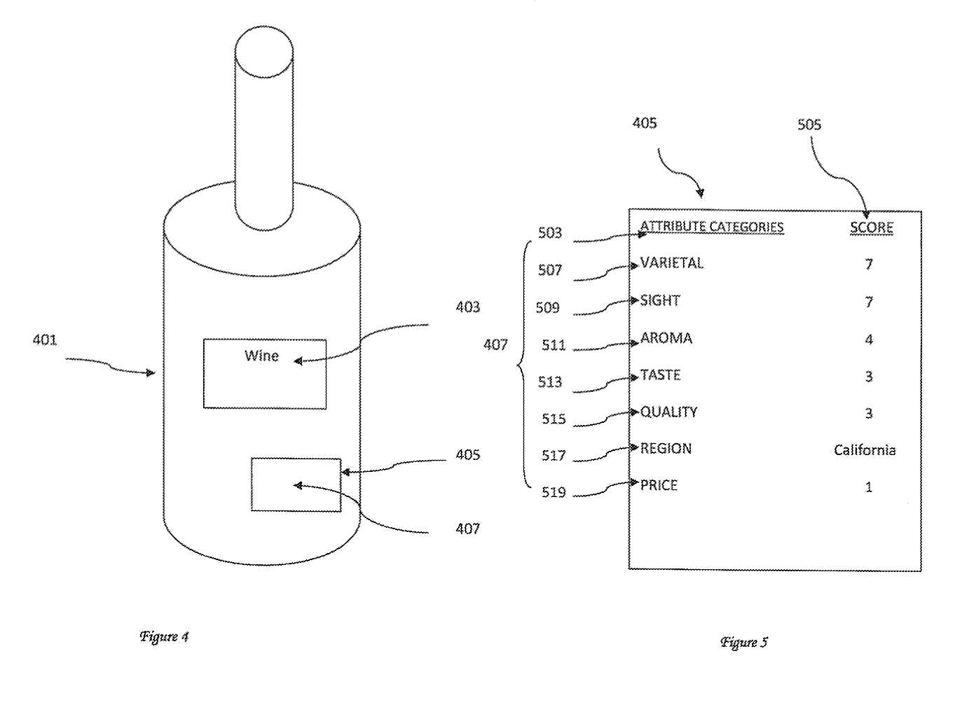

FIG. 3 illustrates an embodiment of the present invention, where there is shown exemplary results 301 for a consumer. Exemplary results 301 can be for a particular consumable good, such as wine, or can be a general summary of the consumer's preferences. Exemplary results 301, organize and tabulate the palate scores 303 for each palate preference category 101. Scores 303 may be in the form of numbers, colors, names, or any other identification or alphanumeric system. Exemplary results 301 can be kept in the form of a card, smartcard, smart phone, software application, or any other form well known to those in the art.

FIG. 4 illustrates an embodiment of the present invention, where there is shown an exemplary consumable good 401. In this diagram, exemplary consumable good 401 is a bottle of wine 403. Wine 403 includes an attribute marker 405, which depicts the consumable good attributes 407 of the wine bottle 403.

FIG. 5 illustrates an embodiment of the present invention, where there is shown an exemplary attribute marker 405 for an exemplary consumable good 401, here a wine bottle 403. As an example, attribute marker 405 lists the consumable good attribute categories 503 for the wine bottle 403. In this example, consumer good attributes 407 include varietal 507, sight 509, aroma 511, taste 513, quality 515, region 517, price range 519. The above listed attribute categories 407 are for exemplary purposes only and any number of attributes can be included for a specific consumable good. As a further example, attribute marker 405, also lists a consumable good score 505 for each consumer good attribute category 503. In one embodiment, consumable good score 505 is based on a scale which can be from “High to Low,” a numbering system, color-coding (dark color to light color) system, or any other similar range, measurement, identification or alphanumeric system which indicates the wine's 403 consumable good attributes 407. In one embodiment, consumable good attribute categories 503 correspond to the consumer's palate preference categories 101.

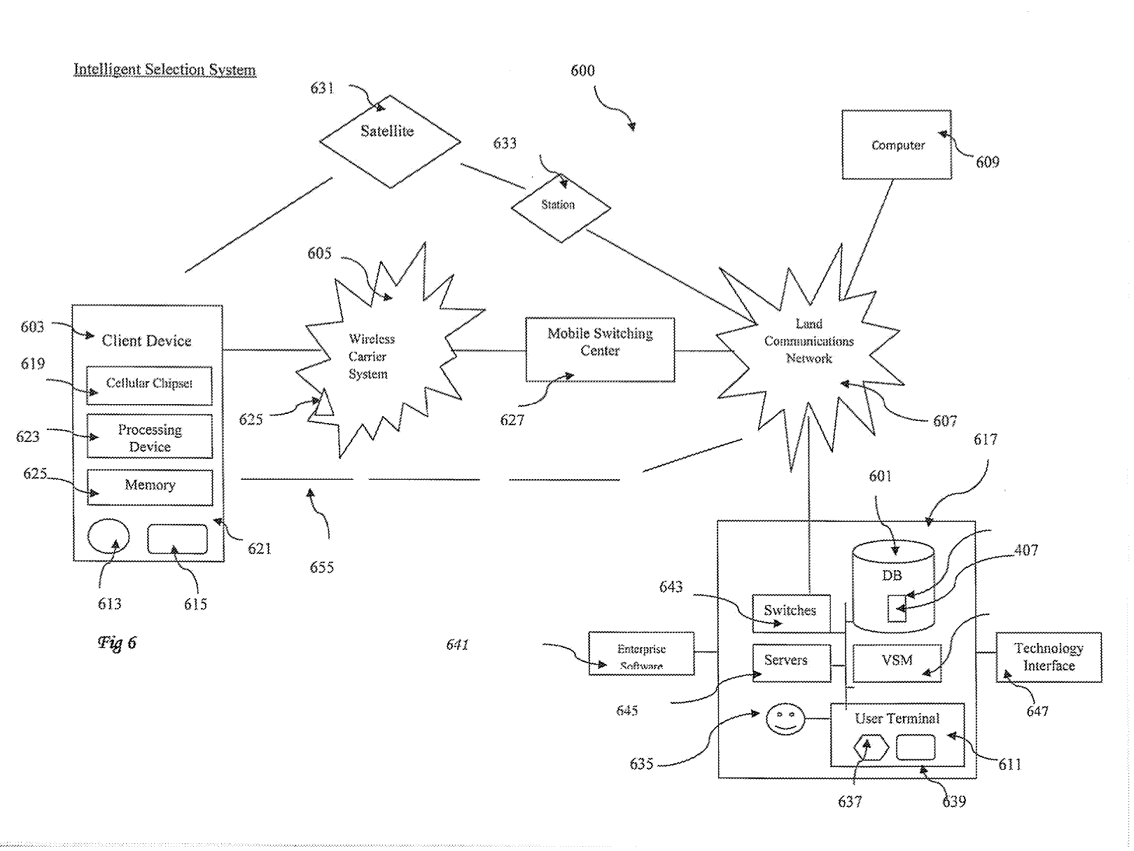

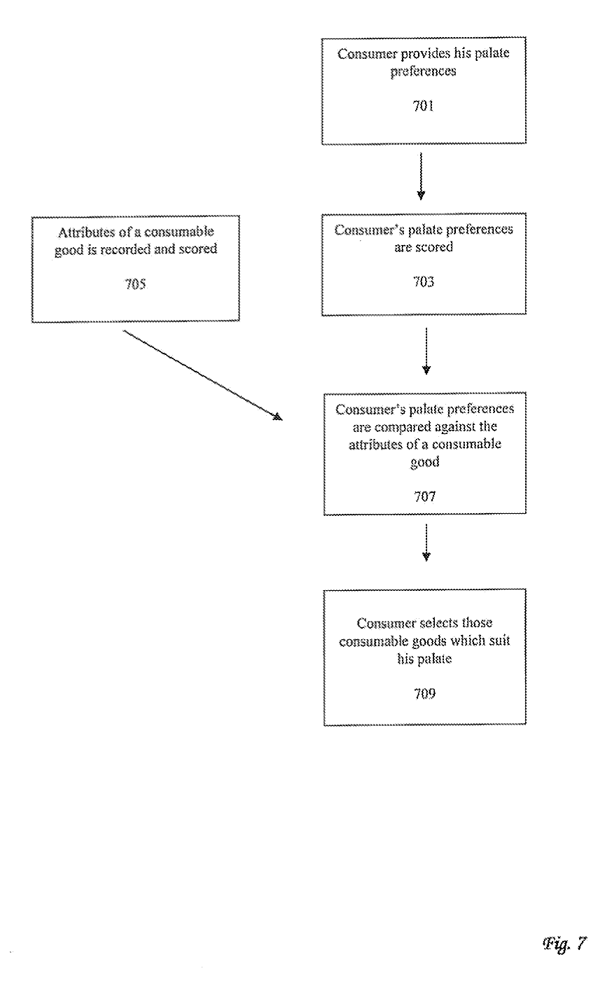

FIG. 6 illustrates an exemplary operating environment that comprises an intelligent selection system 600 that can be used to implement the method disclosed herein. In an embodiment, the intelligent selection system generally includes database 601 and a customized set of consumer palate preferences. Database 601 can contain consumable good attributes 407 for any number of consumable goods 401, such as, for example, if the consumable good is a wine, the database would contain information about the various characteristics and classifications of the wine, such as, for example, price point, sight (clarity, depth, color, viscosity), aroma, taste (sweetness, tannin content, acidity, body, length, balance), quality identifier (coarse, poor, fine, excellent), region, types of grapes used, or any other similar characteristic. In an embodiment these attributes can be assigned alphanumeric values, however, any other assignable system can be used, such as, for example, color codes, symbols, shapes, to name a few.

In an embodiment of the present invention, an exemplary operating environment also includes, such as, for example, a consumer palate preference device 603, one or more wireless carrier systems 605, a land communications network 607, a computer 609, a user terminal 611, to name a few. It should be understood that the disclosed method can be used with any number of different systems and is not specifically limited to the operating environment discussed here. Also, the architecture, construction, setup, and operation of the system and its individual components are generally known in the art, however, they are uniquely applied with this invention. The following paragraphs simply provide a brief overview of one such exemplary system; however, other systems not discussed here could employ the disclosed method as well.

Aspects of the present invention may be implemented in various configurations. For example, in one embodiment the consumer palate preference device 603 may be implemented as a card, smartcard, desktop personal computer, stand alone computer, workstation computer, mobile computer, portable computing device, personal digital assistant (PDA) device, cellular telephone, digital audio or video playback device, or any other similar type of computing device. Device 603 may include a video camera 613 and a voice transmitting and receiving device 615 such as a microphone and audio system in one unit. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

In one embodiment, consumer palate preference device 603 enables wireless data communication over wireless carrier system and via wireless networking so that client device can communicate with center 617. In one embodiment, client device 603 uses radio transmissions to establish a communications channel (such as a data channel) with wireless carrier system 605 so that data transmissions can be sent and received over the communications channel. Data can be sent over a data connection, such as via packet data transmission over a data channel, or via a voice channel using protocols well known in the art. Consumer palate preference device 603 can utilize a single call over a voice channel and switch as needed between voice and data transmission over the voice channel, and this can be done using techniques well known to those skilled in the art.

According to one embodiment, consumer palate preference device 603 utilizes cellular communication according to either GSM or CDMA standards and thus includes a standard cellular chipset 619 for voice communications like hands-free calling, a wireless modem 621 for data transmission, an electronic processing device 623, one or more digital memory devices 625, and a dual antenna (not shown). It should be appreciated that the modem 621 can either be implemented through software that is stored in the client device 603 and is executed by processor 623, or, as mentioned above, it can be a separate hardware component located internal or external to consumer palate preference device. Modem 621 can operate using any number of different standards or protocols, such as, for example, EVDO, CDMA, GPRS, EDGE, to name a few.

Processor 623 can be any type of device capable of processing electronic instructions including microprocessors, microcontrollers, host processors, controllers, vehicle communication processors, and application specific integrated circuits (ASICs). It can also be a dedicated processor 623 used only for consumer palate preference device 603. Processor 623 executes various types of digitally-stored instructions, such as software or firmware programs stored in memory 625, which enable the consumer palate preference device 603 to provide a wide variety of services. For instance, processor 623 can execute programs or process data to carry out at least a part of the processing method discussed herein.

Consumer palate preference device 603 may communicate with the palate preference database 601 via a land communications network 607 or a wireless carrier system 605, or a combination of both, and this can be done using techniques well known to those skilled in the art. Wireless carrier system 605 is preferably a cellular telephone system that includes a plurality of cell towers 625 (only one shown), one or more mobile switching centers (MSCs) 627, as well as any other networking components required to connect wireless carrier system 605 with land network 607 and vice versa. Each cell tower 625 includes sending and receiving antennas and a base station, with the base stations from different cell towers 625 being connected to the MSC 627 either directly or via intermediary equipment such as a base station controller (not shown). Wireless carrier system 605 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system. For instance, the base station and cell tower 625 could be co-located at the same site or they could be remotely located from one another, each base station could be responsible for a single cell tower 625 or a single base station could service various cell towers 625, and various base stations could be coupled to a single MSC 627, to name but a few of the possible arrangements.

Apart from using wireless carrier system 605, a different wireless carrier system in the form of satellite communication 631 can be used to provide bi-directional communication with device 603. This can be done using one or more communication satellites 631 and an uplink transmitting station 633. Bi-directional communication can be, for example, satellite telephony services using satellite 631 to relay telephone communications between the client device 603 and station 633. If used, this satellite telephony can be utilized either in addition to or in lieu of wireless carrier system 605.

Land network 607 may be a conventional land-based telecommunications network that is connected to one or more landline telephones and connects wireless carrier system 605 to center 617. For example, land network 607 may include a public switched telephone network (PSTN) such as that used to provide hardwired telephony, packet-switched data communications, and the Internet infrastructure. One or more segments of land network 607 could be implemented through the use of a standard wired network 655, a fiber or other optical network, a cable network, power lines, other wireless networks such as wireless local area networks (WLANs), or networks providing broadband wireless access (BWA), or any combination thereof. Furthermore, center 617 need not be connected via land network 607, but could include wireless telephony equipment so that it can communicate directly with a wireless network, such as wireless carrier system 605.

A computer 609 can be one of a number of computers accessible via a private or public network such as the Internet. Each such computer 609 can be used for one or more purposes, such as a web server accessible by the client device 603 and wireless carrier 605. Other such accessible computer 609 can be, for example: a service center computer where accounting information and other transaction data can be uploaded from the consumer palate preference device 603. A computer 609 can also be used for providing Internet connectivity such as DNS (Domain Name System) services or as a network address server that uses DHCP (Dynamic Host Configuration Protocol) or other suitable protocol to assign an IP (Internet Protocol) address to the client device 603.

In another embodiment, and as a further example, a live palate preference advisor 635 operates a user terminal 611 to facilitate communication between the consumer using the palate preference device 603, the database 601, and any third party such as a retailer, supplier, marketer, or advertiser. The live palate preference advisor 635 may be implemented as a desktop personal computer, stand alone computer, workstation computer, mobile computer, portable computing device, personal digital assistant (PDA) device, cellular telephone, digital audio or video playback device, or any other similar type of computing device. User terminal 611 may include a display screen 639 and a voice transmitting and receiving device 637 in one unit. In an alternate embodiment, user terminal 611 may be implemented in a plurality of units such as a separate display screen and a separate voice transmitting and receiving device that is linked or networked to user terminal 611. As a further example, user terminal 611 may include similar components, features, and capabilities as those described earlier with respect to the client device 603 (i.e., enablement of wireless voice and/or data communication over wireless carrier system and via wireless networking, utilization of cellular communication, utilization of a processor, communication via a land communications network, satellite communication, etc.) Live palate preference advisor 635 may be engaged with a call center that may employ the use of enterprise software 641 and various technology interfaces 647 that enable the user terminal to communicate with the client device, and perform authentication measures as disclosed herein. The enterprise software and technology interfaces are generally well known to those skilled in the art.

Center 617 is designed to provide client device 603 with a number of different system back-end functions such as the ability to store the client's palate preferences and consumable good attributes. To assist in this endeavor, and according to the exemplary embodiments shown here, generally includes one or more switches 643, servers 645, databases 601, voice response system/voice system module (VSM) 651, all of which are known in the art.

Aspects of the present invention may be implemented on one or more computers executing software instructions. According to one embodiment of the present invention, server and client computer systems transmit and receive data over a computer network or a fiber or copper-based telecommunications network. The steps accessing, downloading, and manipulating the data, as well as other aspects of the present invention are implemented by central processing units (CPU) in the server and client computers executing sequences of instructions stored in a memory. The memory may be random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one of more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform. Aspects of the present invention can be used in a distributed electronic commerce application that included a client/server network system that links one or more server computers to one or more client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “computer network” and “online” may be used interchangeably and do not imply a particular network embodiment or topography. In general, any type of network (e.g., LAN, WAN, or Internet) may be used to implement the online or computer networked implementation of the software.

### Types of Taste Receptors

Scientists have determined that the taste receptors for sour and salty are caused by pore-forming proteins called ion channels. These proteins are found on the area that protects the interior of cells known as the plasma membrane. The main purpose of these channels is to regulate the flow of ions on the tongue based on a charge. Ion channels convey ions such as sodium or potassium through the membrane almost like a gatekeeper. Other factors affecting ion channels are temperature or chemical reactions.

G protein-coupled receptors are found only in eukaryotes and are part of the family of proteins known as transmembrane receptors. Basically, these receptors detect molecules outside of the cell and initiate transduction through pathways in the tongue. G protein-coupled receptors are responsible for the taste sensations of bitter, sweet, and umami.

### Tests

In one embodiment, scientific testing may be used to assist in the collection of information from consumers. For example, PTC or penylthiocarbamide, testing is a widely-used compound in the study of genetics associated with taste. Depending on the individual, it can either taste very bitter or have nearly no taste whatsoever. The PTC test can be used to help identify the genetic background of subjects. While nearly 70 percent of the human population can taste the compound, certain groups of people have higher or lower rates or tasting abilities. The ability to taste PTC (or otherwise) is determined by the PTC gene. There are several different alleles (forms) and what determines the intensity of the bitter taste (how strong it is or even if it has no taste at all) are the shapes of the bitter taste receptor proteins that PTC genes code for, and how strongly these bind to PTC.

So far, geneticists have been unable to identify the exact reason why certain individuals experience stronger sensations in taste than others. These people are called supertasters. Approximately 25 percent of the world's populations are supertasters, most commonly women. It has been shown that these people do have an increased amount of taste buds, however, it does not fully explain the phenomenon. Many scientists believe it may be an evolutionary condition that helped early humans avoids toxic plants that contained alkaloids. In one embodiment, information collected from supertasters may be used to create a database of obtained results.

In an embodiment, these genetic based collected information can be stored in a database, which when completed, in another embodiment will be able to catalog humans into various gene pools which in turn could be used for other purposes, such as, for example, cross-selling, up-selling, marketing, scientific studies, etc. The following articles are incorporated by reference as if fully set forth herein: “Taste and Behavior Genetics” Gene Expression (http://www.gnxp.com/MT2/archives/003665.html); and “Genes and Bitter Taste” University of Utah (http://learn.genetics.utah.edu/content/begin/traits/ptc/)

### Use of the Intelligent Selection Based on Customized Palate Preferences

Turning now to FIG. 7, there is shown an exemplary embodiment of the present invention, depicting some of the steps of the processing method. For example, on one embodiment, a consumer provides his palate preferences 701. In another embodiment of the present invention, the consumer may register online or with a service system and provides a personal code that he will use to access his account with the service in the future. The system walks him through a number of screens to get his personal information and palate preferences pertaining to one or more consumable goods. The consumer's personal information is stored in his account within the search system or the database. When the consumer returns to access the system later, he can just login the system using his personal code and start searching for the consumable good. When logging into the system for the first time, the consumer would be required to provide his personal information. However, for access to the system in the future, he may not be required to provide the personal information, even though he has the option to update his personal information. The system retrieves his personal information using his personal code(s) or security setting(s) and uses it for performing the requested consumable good searches. In one embodiment of the present invention, the consumer's are scored based on the information provided 703. In one embodiment the scores are reproduced on a score card or a smart card such as an electronic swipe-able card. In another embodiment of the present invention, the score card is saved in electronic form, in the form of a software program or software application used on a computer, handheld electronic device, Smartphone PDA, or other similar electronic device known to those who practice in the art.

In one embodiment of the present invention, attributes of a consumable good are recorded and stored 705.

In one embodiment of the present invention, the values assigned to the consumer's preferences can determine the consumable goods, based on a comparison with the attributes of the consumable good that are most suited to the consumer's palate/taste 705. Alternatively, consumable goods that are not suited to the consumer's palate can, be eliminated and/or ignored or omitted altogether or offered with a lower priority.

The intelligent selection based on customized palate preferences system enables consumers to select consumable goods based on individual palate preferences. For example, in one embodiment, the consumer's preferences can be collected and stored in a database which can be accessed via the Internet. In another embodiment, the consumer can then be given a consumer palate preference device which stores the client's preferences based on the consumable good's characteristics either in computer readable format or in a designated alphanumeric, symbolic, or other assignable system can be used, such as, for example, color codes, symbols, shapes, etc., that corresponds to the consumer's preferred consumable good. In another embodiment, the consumer's palate preferences or the designated assignable system can be printed on the consumer palate preference device.

The consumable goods can also be coded with the designated alphanumeric, symbolic, or other assignable system based on its characteristics 705 so that the consumer's palate preferences can be cross-referenced with the consumable good.

In one embodiment, for example, if a seller were to sell the consumable good, the consumer can use his consumer palate preference device to intelligently select the consumable goods more suited to his palate preferences. In one embodiment, the seller may be a restaurateur, in another embodiment the seller may be a retailer, supplier, wholesaler, or any other type of seller known to those skilled in the art, including those who sell consumable goods online via the Internet or similar other media.

In one embodiment a live advisor can be used to interface between the consumer, consumer palate preference device, database and seller, or any combination of the foregoing.

In one embodiment, the consumer's palate preferences are compared against the attributes of a consumable good 707. In another embodiment, the comparison can be done electronically through software applications well known to those who practice in the art. In another embodiment, the comparison can also be done manually by a live advisor or a retailer or by the consumer him or herself.

In another embodiment, the consumer may select those goods which suit the consumer's palate 709. In another embodiment, a computer program, or software program may select those goods which suit the consumer's palate. In another embodiment, a live operator, or an individual may select goods which suit the consumer's palate. In another embodiment, goods which suit the consumer's palate are highlighted. In another embodiment, goods which do not suit the consumer's palate are discouraged, dropped entirely from the selection, or are given lower importance.

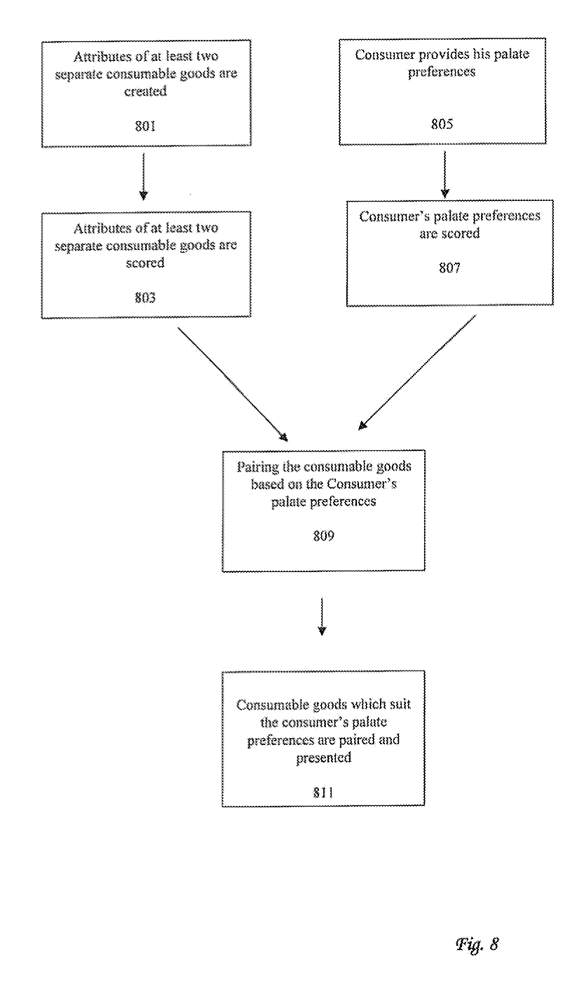

Now turning to FIG. 8 there is shown an exemplary embodiment of the present invention, depicting some of the steps of a method. For example, in one embodiment, attributes of at least two separate consumable goods are created 801. As a further example, attributes of at least two separate consumable goods are scored 803. As a further example, a consumer provides his palate preferences 805. As a further example, the consumer's palate preferences are scored 807. As a further example, the consumable goods are paired using their attributes and scores, based on the consumer's palate preferences 809 and consumable goods which suit the consumer are presented to the consumer 811. In another embodiment any number of these exemplary steps may be performed by a live operator, an individual, the consumer, or a software program or electronic device, well known to those practicing in the art.

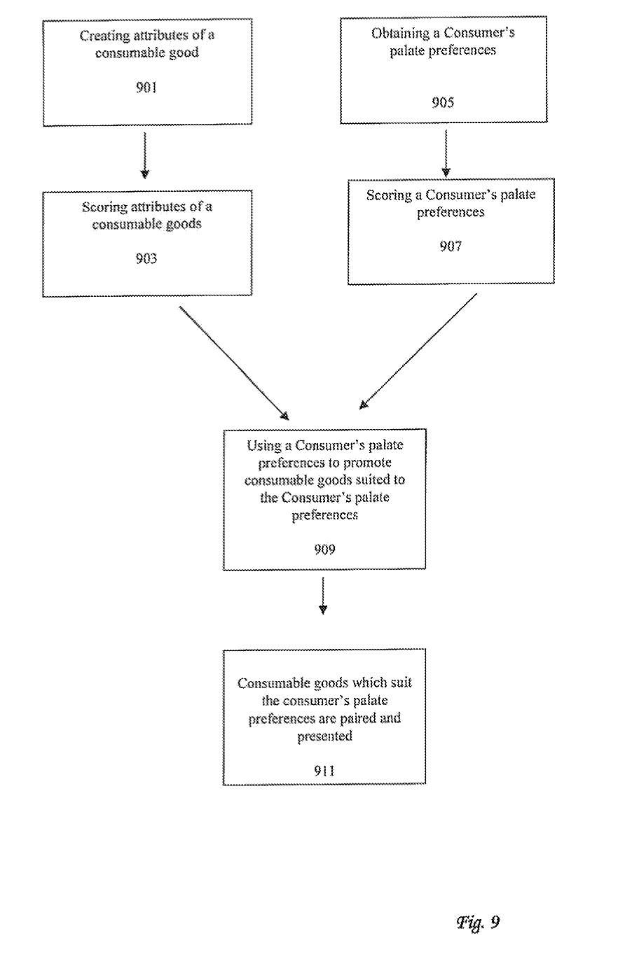

Now turning to FIG. 9 there is shown an exemplary embodiment of the present invention, depicting some of the steps of a method. For example, in one embodiment, attributes of a consumable good is created 901. As a further example, attributes of a consumable good is scored 903. As a further example, a consumer's palate preferences are obtained 905. As a further example, a consumer's palate preferences are scored 907. As a further example, a consumer's palate preferences are used to promote consumable goods suited to the consumer's palate preferences 909. As a further example, consumable goods which suit the consumer's palate preferences are paired and presented to the consumer 811. In another embodiment any number of these exemplary steps may be performed by a live operator, an individual, the consumer, or a software program or electronic device, well known to those practicing in the art.

The present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A system for intelligently selecting consumable goods, comprising:
a consumer palate preference device capable of indicating a consumer's palate preferences, a consumable good having attributes, whereby the consumer's palate preferences are compared against the attributes of the consumable good to determine selection.

2. The system of claim 1, wherein the consumer palate preference device is selected from a group consisting of a card, an electronic smartcard, and a handheld device.

3. The system of claim 1, wherein the consumer's palate preferences are recorded and scored based on palate attributes.

4. The system of claim 1, wherein the attributes of the consumable good are recorded and scored.

5. The system of claim 1, wherein the consumer's palate preferences are stored in a database.

6. The system of claim 1, wherein the attributes of the consumable good are stored in a database.

7. The system of claim 1, wherein the consumer's palate preferences are compared against the attributes of the consumable good electronically.

8. The system of claim 7, wherein consumable goods that are not suited to the consumer's palate preferences are given lower priority.

9. A method of intelligently selecting a consumable good, comprising the steps of:
using a consumer palate preference device having consumer's palate preferences;
comparing the consumer's palate preferences to a consumable good having attributes; and
selecting the consumable good based on the consumer's palate preferences.

10. The method of claim 9, further comprising the step of scoring the consumer's palate preferences.

11. The method of claim 9, further comprising the step of scoring the attributes of the consumable good.

12. The method of claim 9, further comprising the step of storing the consumer's palate preferences in a database.

13. The method of claim 9, further comprising the step of storing the attributes of the consumable good in a database.

14. The method of claim 13, further comprising the step of giving a lower priority to those consumable goods not suited to the consumer's palate preferences.

15. A method of labeling consumable goods, comprising the steps of:
creating attributes for the consumable goods;
scoring the attributes for the consumable goods; and
associating the scores of the attributes with the consumable goods.

16. The method of claim 15, further comprising the step of using alphanumeric characters to represent the attributes of the consumable goods.

17. The method of claim 15, further comprising the step of using a color-coded system to represent attributes of the consumable goods.

18. The method of claim 15, further comprising the step of creating a database to electronically store the attributes and scores of the consumable goods.

19. The method of claim 15, further comprising the step of marking directly on the consumable good the attributes of the consumable goods.

20. A method of intelligently pairing consumable goods, comprising the steps of:
creating attributes for at least two separate consumable goods;
scoring the attributes for the separate consumable goods;
obtaining a consumer's palate preferences; and
pairing the separate consumable goods based on the consumer's palate preferences.

21. The method of claim 20, further comprising the step of scoring the consumer's palate preferences.

22. The method of claim 20, further comprising the step of storing the consumer's palate preferences in a database.

23. The method of claim 20, further comprising the step of storing the attributes of the separate consumable goods in a database.

24. The method of claim 20, further comprising the step of using a computer palate preference device.

25. A method of promoting consumable goods, comprising the steps of:
obtaining a consumer's palate preferences;
scoring the consumer's palate preferences;
creating attributes for a consumable good;
scoring the attributes of the consumable good; and
using the consumer's palate preferences to promote consumable goods suited to the consumer's palate preferences.

26. The method of claim 25, further comprising the step of storing the consumer's palate preferences in a database.

27. The method of claim 25, further comprising the step of storing the attributes of the consumable good in a database.

28. The method of claim 25, further comprising the step of promoting consumable goods suited to the consumer's palate preferences based on the consumer's palate preference score.
